(19) United States
(12) Patent Application Publication
(10) Pub. No.: US 2002/0051194 A1
(43) Pub. Date: May 2, 2002

(54) Printing system providing virtual printing apparatus

(76) Inventor: Masayuki Sakura, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/891,581

(22) Filed: Jun. 27, 2001

(30) Foreign Application Priority Data
Jun. 27, 2000 (JP) 193057/2000
Jun. 25, 2001 (JP) 191453/2001

(51) Int. Cl. G06F 15/00

(52) U.S. Cl. 358/1.15

(57) ABSTRACT

The invention provides a printing system capable of fully utilizing plural printing apparatus, in printing data by dispersion to the plural printing apparatus. For this purpose, the printing system selects two or more printers to be used, according to the set print environment, then generates a specification describing file by constructing a virtual printer from the selected printing apparatus, and generates an image for setting the print attribute based on such file.

### BACKGROUND OF THE INVENTION

1. Field of the Invention

The present invention relates to a printing system provided with a print server apparatus capable of receiving print data transmitted from a client apparatus and transmitting the print data to at least one of plural printing apparatuses, and a print server apparatus, a client apparatus, a print control method and a memory medium therefor.

2. Related Background Art

There is already known a printing system capable of printing a set of print data in dispersed manner among plural printers. Such printing system is so constructed, in case the dispersed printers have same specifications, as to set the printing attribute according to the specifications of one of such printers, and, in case the dispersed printers are different in the specifications, as to set the printing attribute according to the items common in the specifications of the printers.

In the above-mentioned conventional printing system, since the printing attribute is set according to the specifications of one of the printers in case such dispersed printers are common in the specifications, the value set as the printing attribute is limited to a value corresponding to the processing ability of each printer and cannot be set at a value corresponding to the combined processing ability of the printers.

For example, in case of dispersing the printing of a set of print data to five printers having a maximum possible output of 100 copies, the combined maximum possible output in such five printers becomes 500 copies, but the printing attribute can only be set at 100 copies, instead of 500 copies. It is therefore not possible to utilize the plural printers at the maximum capability thereof.

Also in case of printing with the plural printers of mutually different specifications, the print attribute is set according to the items common among the specifications of the printers. It is therefore again impossible to utilize the plural printers at the maximum capability thereof.

### SUMMARY OF THE INVENTION

In consideration of the foregoing, the object of the present invention is to provide a printing system capable of utilizing plural printing apparatuses at the maximum efficiency in printing the print data by the plural printing apparatuses in dispersed manner, and a print server apparatus, a client apparatus, a print control method and a memory medium therefor.

### BRIEF DESCRIPTION OF THE DRAWINGS

FIG. 1 is a block diagram showing the configuration of a printing system constituting a first embodiment of the present invention;

FIG. 2 is a view showing the content of description of a printer specification describing file held by a print server apparatus 101 shown in FIG. 1;

FIG. 3 is a view showing the content of description of a virtual printer specification describing file held by the print server apparatus 101 shown in FIG. 1;

FIG. 4 is a view showing a printer setting dialogue to be used for setting the printing environment on a client computer 102 shown in FIG. 1;

FIG. 5 is a view showing a printing dialogue to be used for setting the printing attribute on the client computer 102 shown in FIG. 1;

FIG. 6 is a flow chart showing the process sequence by a print control program the client computer 102 shown in FIG. 1;

FIG. 7 is a flow chart showing the process sequence of the print server apparatus 101 shown in FIG. 1;

FIG. 8 is a view showing a printer setting dialogue to be used for setting the printing environment on the client computer 102 of a printing system constituting a second embodiment of the present invention;

FIG. 9 is a view showing the content of description of a printer specification describing file of a printer 103 in the printing system of the second embodiment of the present invention;

FIG. 10 is a view showing the content of description of a printer specification describing file of a printer 104 in the printing system of the second embodiment of the present invention;

FIG. 11 is a view showing the content of description of a virtual printer specification describing file generated by a virtual printer generating function of the print server apparatus 101 of the printing system of the second embodiment of the present invention;

FIG. 12 is a view showing a printing dialogue to be used for setting the printing attribute on the client computer 102 of the printing system of the second embodiment of the present invention;

FIG. 13 is a view showing a printing dialogue to be used for setting the printing attribute on the client computer 102 of a printing system constituting a third embodiment of the present invention; and

FIG. 14 is a view showing a method for supplying a computer with the computer program of the present invention.

### DESCRIPTION OF THE PREFERRED EMBODIMENTS

Now the present invention will be clarified in detail by embodiments thereof, with reference to the accompanying drawings.

(First Embodiment)

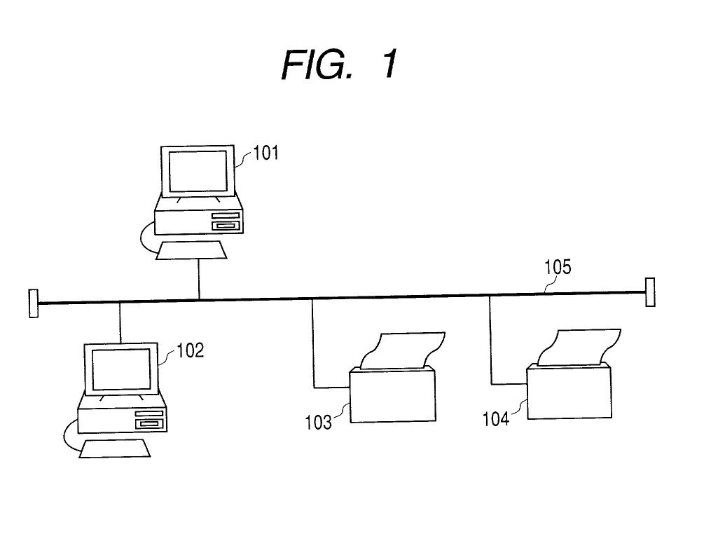

FIG. 1 is a block diagram showing the configuration of a printing system constituting a first embodiment of the present invention.

As shown in FIG. 1, the printing system is composed of two printers 103, 104, a client computer 102 and a printer server apparatus 101.

The printers 103, 104 are connected to a computer network 106 consisting for example of ethernet. The client computer 102 has a print control program (printer driver) for generating print data and setting the print environment and the print attribute (both being printing parameters) and is connected to a computer network 105.

The print server apparatus 101 is capable of receiving the print data, transmitted from the client computer 102 through the computer network 105 and transmitting the received print data to at least one of the printers 103, 104. The number of the printers is not limited to two but can be three or larger.

The print server apparatus 101 consists of a server apparatus composed of peripheral circuits including a CPU (not shown), a ROM, a RAM, an HDD (not shown) etc., and executes various processes and controls by the execution of application programs stored in the HDD by the CPU.

The print server apparatus 101 is capable of executing a dispersed print control process, which consists of a holding function, a set information obtaining function, a virtual printer generating function and a transmission control function.

The holding function is to hold a printer specification describing file in which the specifications of the printers 103, 104 are described. The data format of the printer specification describing file can be data described with XML (extensible markup language) or HTML (hyper text markup language) or data described with texts and numerals and is not particularly limited.

The set information obtaining function is to obtain, through the computer network 105, the print environment and the print attribute (collectively called print parameters) set by the client computer 102.

The virtual printer setting function is to construct a virtual printer consisting of at least two of the printers 103, 104 according to the printer specification describing file and the obtained print environment, and generating a virtual printer specification describing file of such virtual printer. The transmission control function is to transmit the received set of the print data to the printers 103, 104 constituting the virtual printer, according to the obtained print attribute.

The client computer 102 consists of a personal computer composed of peripheral circuits including a CPU (not shown), a ROM, a RAM, an HDD (not shown) etc., and executes various processes and controls by the execution of application programs stored in the HDD by the CPU.

The above-mentioned print control program is stored in the HDD, and the functions realized by the execution of the print control program by the CPU include a virtual printer specification describing file obtaining function and a user interface generating function.

The virtual printer specification describing file obtaining function is to obtain the virtual printer specification describing file from the print server apparatus 101 through the computer network 105. The user interface generating function is to generate a user interface for setting the print attribute based on the obtained virtual printer specification describing file.

In the present embodiment, it is assumed that the printers 103, 104 are of a same type (for example type A), each having five output bins (not shown).

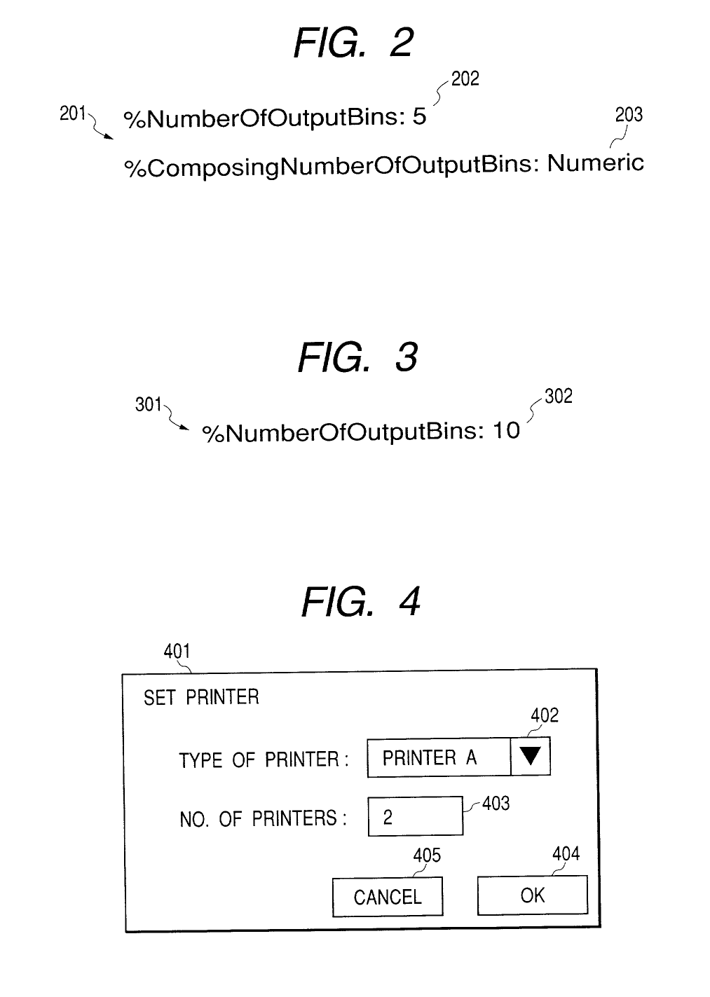

In the following there will be explained the virtual printer generating function of the print server apparatus 101 with reference to FIGS. 2 and 3. FIG. 2 shows the content of description of the printer specification describing file held by the print server apparatus 101 shown in FIG. 1, and FIG. 3 shows the content of description of the virtual printer specification describing file generated by the virtual printer generating function of the print server apparatus 101 shown in FIG. 1.

As explained in the foregoing, the virtual printer generating function is a function for constructing a virtual printer consisting of at least two of the printers 103, 104 according to the printer specification describing file and the obtained print environment, and generating a virtual printer specification describing file of such virtual printer.

The printer specification describing file describes the specifications of the printers 103, 104. As shown in FIG. 2, in the file, a line indicating the specifications (line 201) starts with “%”, followed by a keyword (“NumberOfOutputBins”) indicating the content of the specification, then “:”, and a value (“5”) of the specification. Thus the description of the first line indicates that the number of the output bins is 5.

A second line starts with “%Composing”, followed by a keyword indicating the content of the specification (“NumberofoutputBins”) and a description “Numeric”. This line indicates that the “NumberOfOutputBins” is synthesizable and that the value thereof is a number. Therefore, in synthesizing, the value can be subjected to an arithmetic calculation.

Since the printers 103, 104 are of a same type in the present embodiment, same printer specifications are described for the printers 103, 104 in the printer description list.

The printer specification describing file can be renewed whenever necessary by an input operation of the user on the client computer 102. The renewal may also be executed by an input operation of the user on the print server apparatus.

The print environment (print parameter) is set by the user on the client computer 102. As the print environment, there are for example set the type of the used printer and the number thereof. The setting of the print environment will be explained later.

As shown in FIG. 3, the virtual printer specification describing file generated by the virtual printer generating function has a format same as that of the printer specification describing file shown in FIG. 2. In the virtual printer specification describing file, a line indicating the specifications (line 301) starts with “%”, followed by a keyword (“NumberOfOutputBins”) indicating the content of the specification, then “:”, and a value (“10”) of the specification.

The present embodiment shows a case where the user sets the A type as the type of the used printer and 2 printers as the number thereof. In response, the print server apparatus 101 selects the printers 103, 104 from such print environment, and obtains a value “10” as the number of the output bins usable in the virtual printer (composed of the printers 103, 104), based on the number “5” of the output bins thereof.

In the following there will be explained, with reference to FIG. 4, the setting of the print environment on the client computer 102. FIG. 4 shows a printer setting dialog to be used in setting the print environment on the client computer 102 shown in FIG. 1.

The setting of the print environment is executed according to the print control program (printer driver). In such setting, there is displayed a printer setting dialog 401 shown in FIG. 4.

The printer setting dialog 401 is used for setting the type of the printer to be used and the number thereof. In this dialog, there are displayed a list 402 for designating the type of the printer to be used, a box 403 for designating the number of the printers to be used, an OK button 404 for designating the setting of the input value, and a cancel button 405 for canceling the set value.

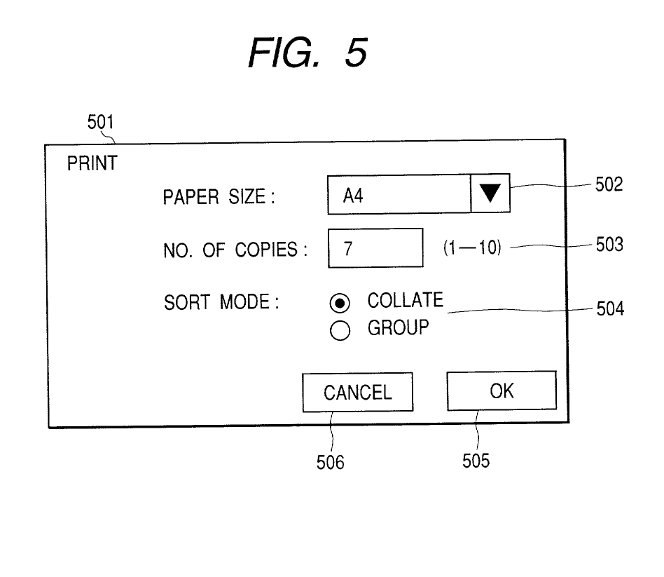

In the following there will be explained, with reference to FIG. 5, the setting of the print attribute on the client computer 102. FIG. 5 shows a print dialog to be used in setting the print attribute (print parameter) on the client computer 102 shown in FIG. 1.

The setting of the print attribute is executed according to the print control program (printer driver). In such setting, there is displayed a print dialog 501 shown in FIG. 5.

The print dialog 501 is used for setting the attribute necessary for printing. This dialog is generated based on the virtual printer specification describing file generated by the print server apparatus 101. In the present embodiment, there are displayed a list 502 for designating the paper size, a box 503 for designating the number of copies in case of output to the output bins, a radio button 504 for designating a sort mode, an OK button 505 for instructing the start of printing, and a cancel button 506 for canceling the printing.

Numbers that can be entered into the list 502 for designating the paper size (sheet size) and the box 503 for designating the number of copies in case of output to the output bins are limited by the virtual printer specification describing file generated by the print server apparatus 101. For example, if a value exceeding the limit is entered, such entered value is not accepted. If the paper size usable in the virtual printer is limited to the A4 size, the list 502 displays “A4” only. Also in case the number of the output bins usable in the virtual printer is “10”, there can only be set a number not exceeding 10 in the box 503.

Also the modes selectable by the radio button 504 for designating the sort mode are likewise limited by the virtual printer specification describing file, and such limited modes are displayed as selectable. In the present embodiment, there can be selected a collation sorting or a group sorting as the sort modes.

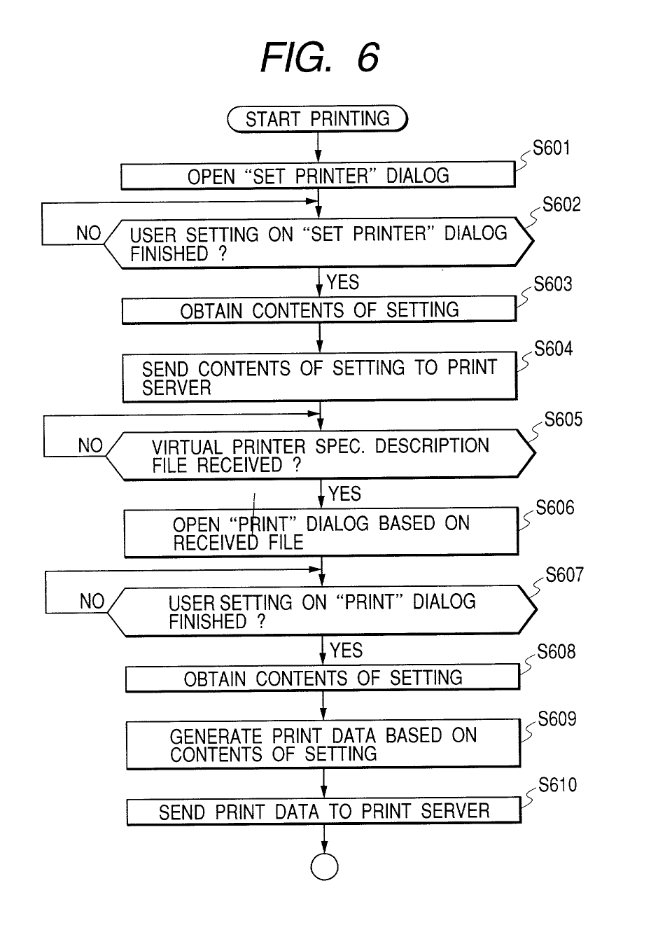

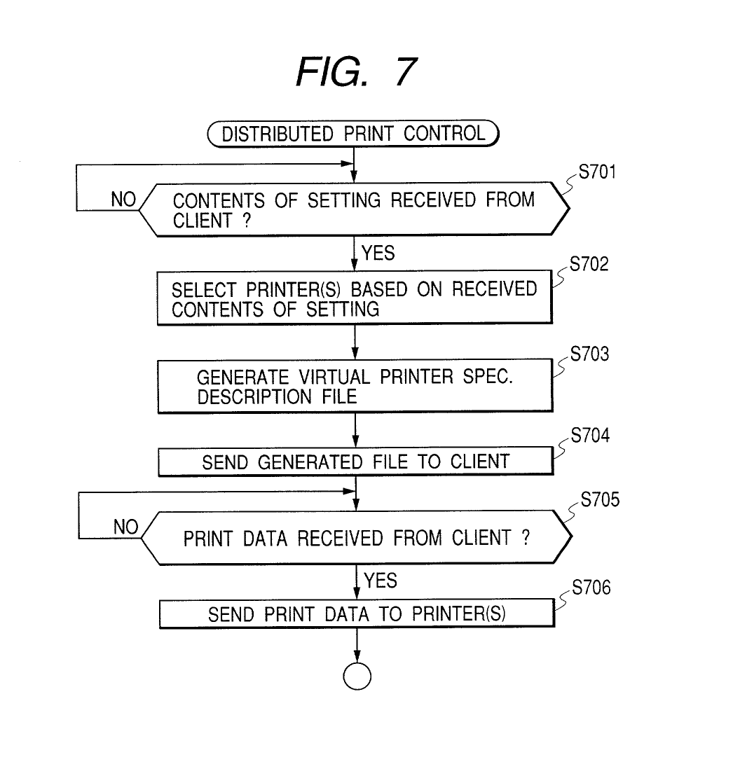

In the following the process sequence of the present printing system will be explained with reference to FIGS. 6 and 7. FIG. 6 is a flow chart showing the process sequence of the print control program in the client computer 102 in FIG. 1, and FIG. 7 is a flow chart showing the process sequence of the print server apparatus 101 shown in FIG. 1. In the following there will be explained a case where a document prepared by the user is printed in 7 copies with the two printers 103, 104.

The client computer 102 executes the print process according to the print control program. In this print process, as shown in FIG. 6, a step 601 at first opens the printer setting dialog (shown in FIG. 4) in response to an input operation of the user.

It is assumed that, in the printer setting dialog, there have been set the A type as the type of the printers to be used and 2 as the number of the printers. Then a step S602 awaits the completion of the user setting on the printer setting dialog, and, upon completion, the sequence proceeds to a step S603.

A step S603 obtains the content set on the printer setting dialog, and a step S604 transmits the set content on the printer setting dialog to the print server apparatus 101 through the computer network 105. The transmitted information is the print environment set in the image shown in FIG. 4.

Then a step S605 awaits the reception, from the print server apparatus 101, of the virtual printer specification describing file (shown in FIG. 3) generated by the print server apparatus 101 based on the set content on the printer setting dialog.

In response to the reception of the virtual printer specification describing file from the print server apparatus 101, the sequence proceeds to a step S606 for generating and opening the print dialog (shown in FIG. 5) corresponding to the virtual printer specification describing file. The print dialog may be opened automatically or in response to an input operation of the user.

In the print dialog, it is assumed that a value 7 copies is set, with respect to the aforementioned upper limit of 10 copies for the output utilizing the output bins. Then a step S607 awaits the completion of the user setting on the print dialog, and, upon completion, the sequence proceeds to a step S608.

A step S608 obtains the content set on the print dialog, and a step S609 generates print data based on the set content of the print dialog. Then a step S610 transmits the print data to the print server apparatus 101 through the computer network 105. The print data contain the print parameter set in the print dialog and image data. The print parameter and the image data need not be transmitted integrally but may be transmitted within a serial flow. The data transmitted in such flow may also be called a print job.

In the print server apparatus 101, the CPU executes a dispersed print control process by executing an application program stored in the HDD. In such dispersed print control process, as shown in FIG. 7, a step S701 at first awaits the reception of the set content of the print environment, set by the client computer 102.

In response to the reception of the set content of the print environment from the client computer 102, the sequence proceeds to a step S702 to determine the printer according to the set content of the received print environment. As the print environment sets the A type as the type of the used printers and 2 as the number thereof, there are accordingly selected the printers 103, 104 for generating a virtual printer.

Then a step S703 generates a virtual printer specification describing file, describing the specifications obtained by combining the determined printers. For this purpose, there are at first read the printer description describing files of the printer type A (printers 103, 104), and the virtual printer specification describing file is prepared from the printer specification describing files of the printers.

For example, in case of the printer specification describing file shown in FIG. 2, the print server apparatus 101 recognizes, from the description “%NumberOfOutputBins:5” that the printer is provided with 5 output bins. Also from the description “%ComposingNumberOfOutputBins:Numeric” in the next line, it is recognized that, in case of using plural printers, this function is synthesizable and the value of the specification can be handled as a numerical number in synthesizing.

Consequently, in the virtual printer consisting of the printers 103 and 104, the maximum number of the output bins is judged as 10, and there is generated a virtual printer specification describing file (shown in FIG. 3) including a description “%NumberOfOutputBins:10”. In the foregoing there has been explained the case on the output bins, but similar processes are executed also on other functions of the printers.

Then a step S704 transmits the virtual printer specification describing file to the client computer 102 through the computer network 105. Then a next step S705 awaits the reception of the print data, which include the print attribute set on the print dialog in the client computer 102, corresponding to the virtual printer specification describing file. Upon receiving the print data including the print attribute, the sequence proceeds to a step S706.

A step S706 discriminates whether or not to disperse the print data, according to the set print attribute. Also, in case of dispersing the print data, there are determined the respective output addresses of the dispersed print data. Then the dispersed print data are transmitted to the respective printers.

More specifically, since the print attribute sets the printing of 7 output copies with the output bins, 4 copies and 3 copies in the 7 output copies are respectively assigned to the printer 103 and the printer 104. Then the print data are so generated as to print 4 copies and transmitted to the printer 103, and the print data are so generated as to print 3 copies and transmitted to the printer 104.

In the present embodiment, after the transmission of the print data to the printers 103, 104, the content of the transmission control for the print data is informed to the client computer 102. In the present embodiment, the client computer 102 is informed of a fact that 4 copies and 3 copies in the 7 output copies are respectively assigned to the printer 103 and the printer 104 and the print data are so generated and transmitted as to execute the print outputs of the corresponding copies in the printers 103, 104. Such informing can be set at such an arbitrary timing as after the completion of transmission of the print data. This informing allows the user to know the output printers for the print data and the copy number to be outputted at each output printer.

As explained in the foregoing, the present embodiment determines at least two printers to be used according to the print environment (printer type, number of printers) set by the user, constructs a virtual printer from such at least two printers, and generates a virtual printer specification describing file describing the functions obtained from the combination of such at least two printers, thereby enabling to set the print attribute based on such virtual printer specification describing file, so that the function or the maximum possible output copy number obtained from the combination of the two or more printers can be increased to achieve maximum effective utilization of the printers.

In the present embodiment, there have been shown two printers 103, 104 as the printers connected to the computer network 105, but it is naturally possible, also in case three or more printers are connected to the computer network, to construct a virtual printer by combining such printers and to fully utilize such printers.

(Second Embodiment)

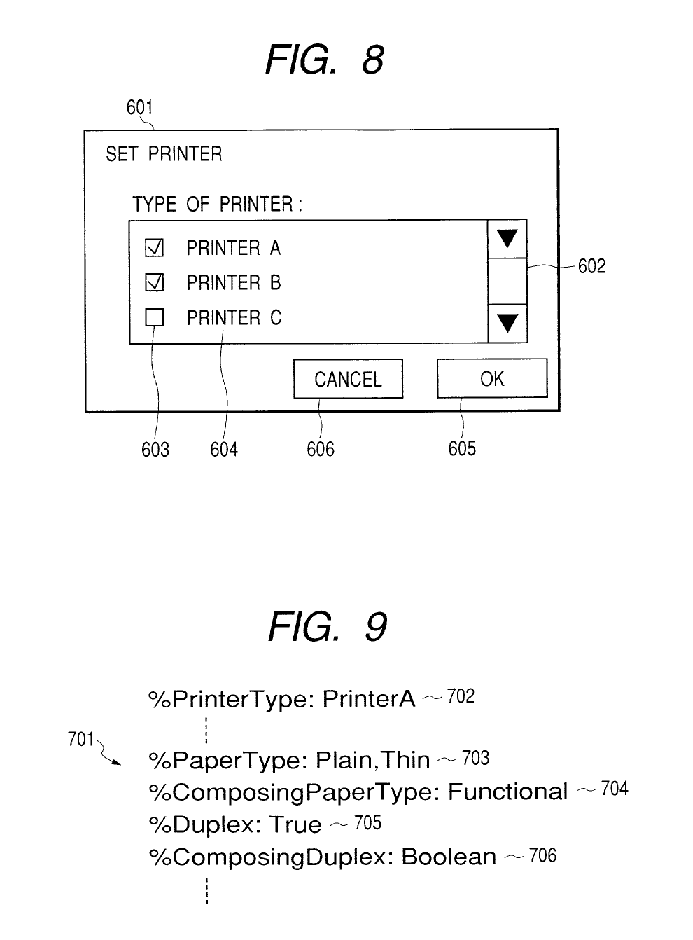

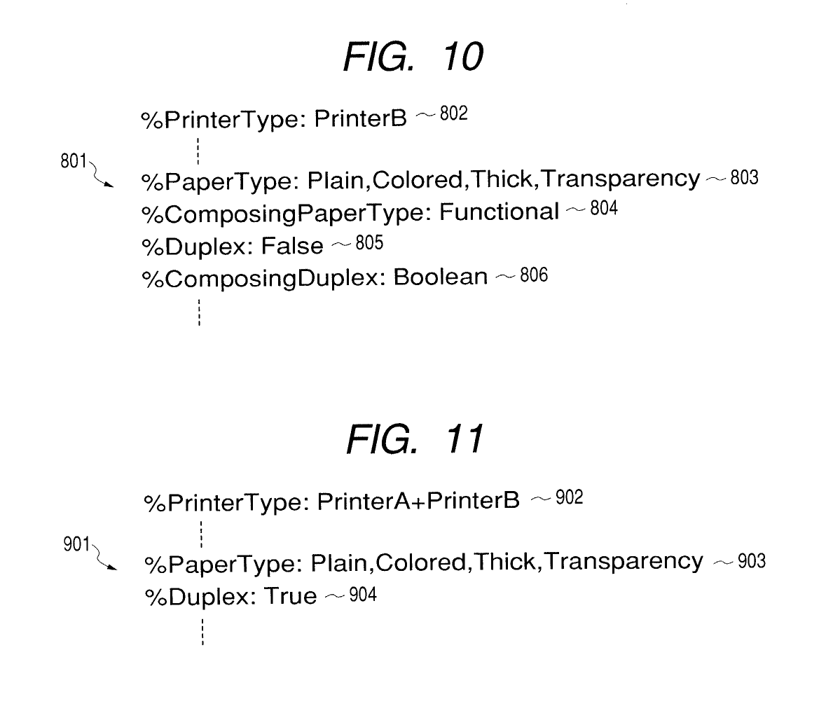

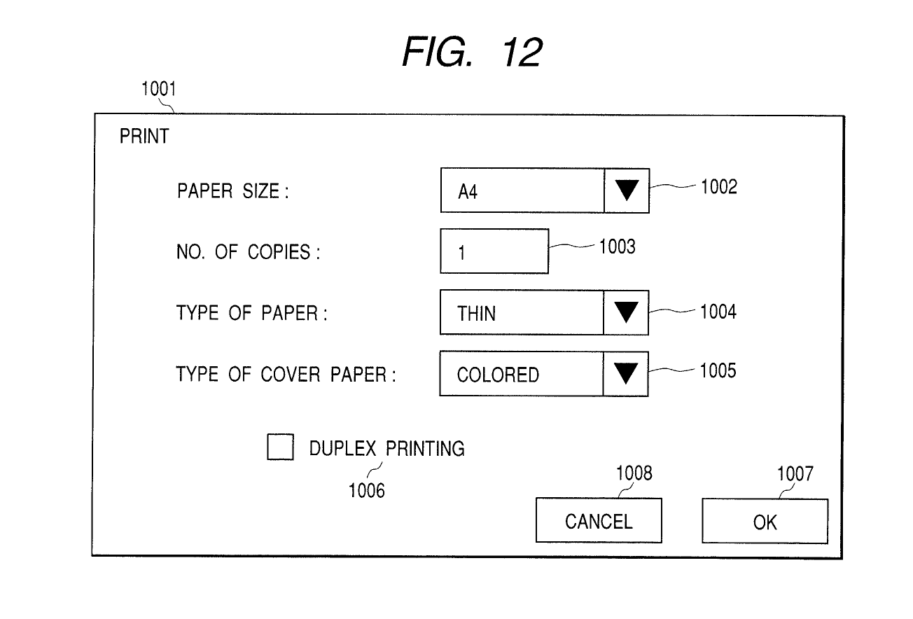

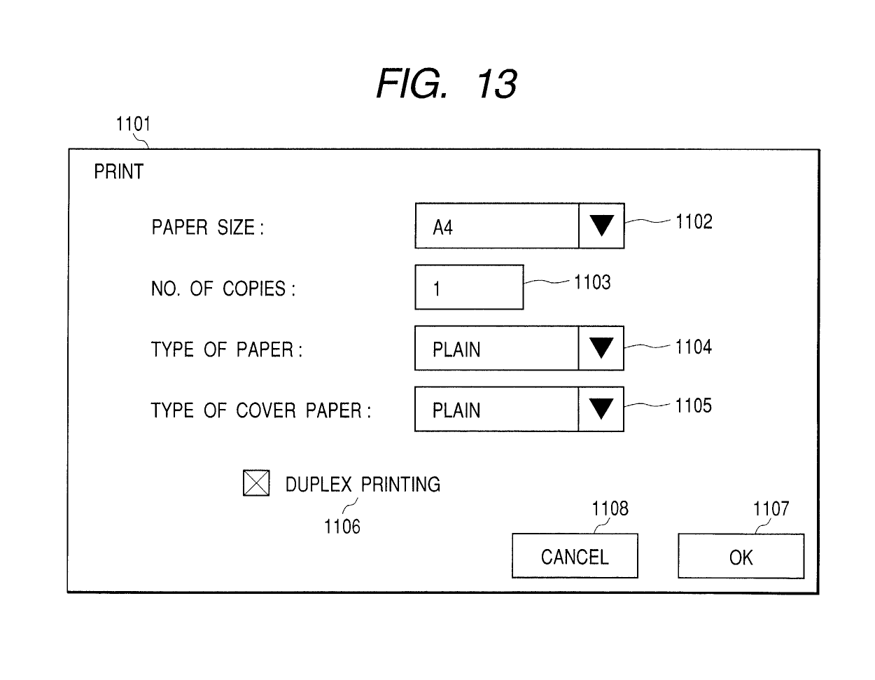

In the following there will be explained a second embodiment of the present invention with reference to FIGS. 8 to 12. FIG. 8 is a view showing a printer setting dialog to be used for setting the print environment on the client computer 102 in a printing system constituting a second embodiment of the present invention. FIG. 9 is a view showing the content of description of a printer specification describing file of the printer 103 of the printing system of the second embodiment. FIG. 10 is a view showing the content of description of a printer specification describing file of the printer 104 of the printing system of the second embodiment. FIG. 11 is a view showing the content of description of a virtual printer specification describing file generated by a virtual printer generating function of the printer server apparatus 101 of the printing system of the second embodiment. FIG. 12 is a view showing a print dialog to be used for setting the print attribute on the client computer 102 in the printing system of the second embodiment of the present invention. The second embodiment is same in the configuration as the first embodiment so that the configuration will not be explained further.

In the present embodiment, the printers 103, 104 are of mutually different types. It is assumed that the printer 103 is of A type while the printer 104 is of B type. In the present embodiment, there will be explained a case where the printers 103, 104 are used to print the cover page with a colored paper and other pages with a thin paper.

In the following there will be explained, with reference to FIG. 8, the setting of the print environment on the client computer 102.

The setting of the print environment is executed according to the print control program (printer driver). In such setting, there is displayed a printer setting dialog 601 shown in FIG. 8. The printer setting dialog 601 is used for setting the type of the printer to be used and the number thereof. In this dialog, there are displayed a list 602 for selecting the printer to be used, an OK button 605 for designating the setting of the input value, and a cancel button 606 for canceling the set value.

In the list 602, there are displayed printer types 604, and check boxes 603 for designating the printer type to be used for printing among such printer types. In the present embodiment, there are selected the printer A and the printer B as the printer types to be used for printing.

The print environment thus set is transmitted to the print server apparatus 101, which determines the printers to be used for printing based on the print environment set in the client computer 102 and the printer specification describing files. FIGS. 9 and 10 shows examples of the printer specification describing file used for determining the printers.

A printer specification describing file 701 shown in FIG. 9 is for the printer 103 of the A type, and, in this file, a first line 702 starts from “%PrinterType” indicating the printer type (“PrinterA” in this case). Thus this printer specification describing file represents the specifications of the printer A (103).

A second line 703 starts from “%PaperType” and describes the paper type (kind) supported by the printer A (103). In the present embodiment, the supported paper type includes plain paper (Plain) and thin paper (Thin).

A third line 704 starts from “%ComposingPaperType” and describes that the paper type can be synthesized with the paper type supported by other printers in case of using plural printers. It is therefore rendered possible to set a print process utilizing the paper types supported by the respective printers.

A fourth line 705 starts from “%Duplex” and describes that the printer A supports the two-side printing. A fifth line 706 starts from “%ComposingDuplex” and describes that the two-side printing can be supported also in case of using plural printers in combination. It also describes that a Boolean value (a value processed by a Boolean operator) indicates whether the two-side printing is possible. It is thus rendered possible to set the two-side printing even in case of using plural printers in combination.

A printer specification describing file 801 shown in FIG. 10 is for the printer 104 of the B type, and, in this file, a first line 802 starts from “%PrinterType” indicating the printer type (“PrinterB” in this case). Thus this printer specification describing file represents the specifications of the printer B (104).

A second line 803 starts from “%PaperType” and describes the paper type (kind) supported by the printer B (104). In the present embodiment, the supported paper type includes plain paper (Plain), colored paper (Colored), thick paper (Thick) and OHP sheet (Transparency).

A third line 804 starts from “%ComposingPaperType” and describes that the paper type can be synthesized with the paper type supported by other printers in case of using plural printers. It is therefore rendered possible to set a print process utilizing the paper types supported by the respective printers.

A fourth line 805 starts from “%Duplex” and describes that the printer B supports the two-side printing. A fifth line 806 starts from “%ComposingDuplex” and describes that the two-side printing can be supported in a combination with a printer having the two-side printing function.

At first the print server apparatus 101 determines the printers based on the received print environment and the above-mentioned printer specification describing file. Since the print environment sets the A and B types as the printer type to be used, there are selected the printers 103, 104 according to the set content of the print environment. Then there is generated a virtual printer specification describing file, describing the specifications obtained by combining the selected printers.

More specifically, at first the printer server apparatus 101 reads the printer specification describing files of the printer type A and the printer type B. Then, based on the lines 703, 803 of the description “%PaperType” in the two printer specification describing files, it is recognized that the printer A supports the plain paper (Plain) and thin paper (Thin) as the paper types and the printer B supports the plain paper (Plain), colored paper (Colored), thick paper (Thick) and OHP sheet (Transparency) as the paper types.

Then, based on the next line 704, 804 of the description “%ComposingPaperType”, it is recognized that the paper size can also be combined in case of combining plural printers. It is therefore determined that the virtual printer can support the plain paper (Plain), thin paper (Thin), colored paper (Colored), thick paper (Thick) and OHP sheet (Transparency).

Then, based on the line 705, 805 of the description “%Duplex”, the print server apparatus 101 recognizes that the printer A supports the two-side printing but the printer B does not support the two-side printing.

However, based on the line 706, 806 of the description “%ComposingDuplex”, it is recognized that the two-side function can be synthesized even in case of combining plural printers. It is therefore determined that the virtual printer supports the two-side printing.

The functions obtained by combining the printers 103, 104 are described in the virtual printer specification describing file 901 as shown in FIG. 11.

More specifically, in the printer specification describing file 901, a first line 902 starts from “%PrinterType” indicating the configuration of the virtual printer (“PrinterA+PrinterB” in this case). Thus this printer specification describing file represents the specifications of the virtual printer obtained by combining the printer A (103) and the printer B (104).

A second line 903 starts from “%PaperType” and describes the paper type (kind) supported by the virtual printer. In the present embodiment, the supported paper type includes plain paper (Plain), thin paper (Thin), colored paper (Colored), thick paper (Thick) and OHP sheet (Transparency). A third line 904 starts from “%Duplex” and describes that the virtual printer supports the two-side printing.

The virtual printer specification describing file is transmitted to the client computer 102 through the computer network 105. Receiving the virtual printer specification describing file, the client computer 102 generates a print dialog for setting the print attribute based on the virtual printer specification describing file.

Then, as shown in FIG. 12, the print dialog 1001 is opened in response to an input operation of the user or automatically. The print dialog 1001 is used for setting the print attribute.

In the print dialog 1001, there are displayed a list 1002 for designating the paper size, a box 1003 for designating the number of the output copies, a list 1004 for designating the paper type, a list 1005 for designating the paper type of the cover sheet, a check button 1006 for designating the two-side printing, an OK button 1007 for instructing the start of printing, and a cancel button 1008 for canceling the printing.

Numbers that can be entered into the list 1002 for designating the paper size, the box 1003 for designating the output copy number, the list 1004 for designating the paper type and the list 1005 for designating the paper type of the cover sheet are limited by the virtual printer specification describing file generated by the print server apparatus 101. For example, if a value exceeding the limit is entered, such entered value is not accepted.

As an example, it is assumed that the A4 size is set as the paper size, 1 copy is set as the output copy number, the thin paper is set as the paper type and the colored paper is set as the paper type for the cover sheet. However the two-side printing is not set. In this example, therefore, the setting is so made as to print the cover sheet with the colored paper and other pages with the thin paper, utilizing the printers 103, 104.

Upon completion of the setting of the print attribute on the print dialog, the set print attribute is transmitted, together with the print data, to the print server apparatus 101 through the computer network 105. Having received the print attribute and the print data, the print server apparatus 101 transmits the print data to the printers 103, 104 in dispersed manner so as to output the cover sheet with the colored paper and other pages with the thin paper, based on the received print data. More specifically, the print server apparatus transmits the data corresponding to the cover sheet to the printer 104 capable of printing with the colored paper and the data corresponding to other pages to the printer 103 capable of printing with the thin paper.

As explained in the foregoing, the present embodiment determines at least two printers to be used according to the print environment (plural printer types) set by the user, constructs a virtual printer from such at least two printers, and generates a virtual printer specification describing file describing the functions obtained from the combination of such at least two printers, thereby enabling to set the print attribute based on such virtual printer specification describing file, so that the functions or the kinds of the processable paper types obtained from the combination of the two or more printers can be increased to achieve maximum effective utilization of the printers.

In the following there will be explained a case where the user executes two-side printing by designating the prints of the A type and the B type.

Having received the virtual printer specification describing file, the client computer 102 opens the print dialog 1101 generated according to the virtual printer specification describing file. The print dialog is same in configuration as the print dialog 1001 shown in FIG. 12.

As an example, it is assumed that the A4 size is set as the paper size, 1 copy is set as the output copy number, the plain paper is set as the paper type and the plain paper is set as the paper type for the cover sheet. Also the two-side printing is set. In this example, therefore, the setting is so made as to print all the pages with the plain paper and with the two-side printing, utilizing the printers 103, 104.

Upon completion of the setting of the print attribute on the print dialog, the set print attribute is transmitted, together with the print data, to the print server apparatus 101 through the computer network 105. Having received the print attribute and the print data, the print server apparatus 101 transmits the print data to the printer 103 capable of the two-side printing, so as that all the pages including the cover sheet are outputted on the plain paper by the two-side printing, but does not transmit the print data to the printer 104.

In the present embodiment, therefore, in setting the print attribute based on the virtual printer specification describing file, even in case of a setting of utilizing the two-side printing, which is the function available only in a printer among the functions obtained by the combination of the two or more printers, the printing can be executed with the printer capable of such two-side printing.

In the foregoing embodiments, as the functions obtainable from the combination of the two or more printers, there have been explained a function for outputting an output copy number which is the sum of the respective output copy numbers of the two or more printers, a function for output with the paper types respectively processable in the two or more printers, and a function of two-side printing, but the present invention is also applicable to other functions such as a function for output with a number of sorter bins which is the sum of the respective sorter bins of the two or more printers, or a function for output with the font types respectively processable in the two or more printers.

The present invention is further applicable to a combination including a printer with sheet processing function. Such sheet processing function includes, for example, stapling, book binding, folding, punching, gluing, enveloping and private box delivery.

The program of the present invention and the related data are stored in a floppy disk (FD) or a CD-ROM and are supplied to the computer therefrom. The memory area in the FD or CD-ROM is composed of volume information, directory information, an execution file (program codes) for the program of the present invention and related data files.

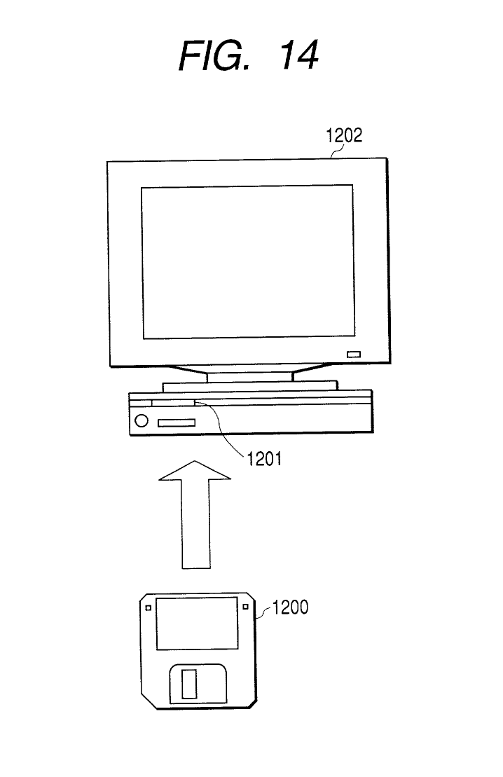

The object of the present invention can also be attained by supplying the computer with a memory medium storing the program codes (those corresponding to the steps in FIGS. 6 and 7) of a software (control program) realizing the functions of the aforementioned embodiments as shown in FIG. 14, and reading and executing the program codes stored in the memory medium by the CPU of the computer.

For supplying the computer with the program and data, there is generally employed a method of storing such program and data in a floppy disk FD 1200 as shown in FIG. 14 and supplying the main body 1202 of the computer with such program and data (through a floppy disk drive 1201). In such case, the program codes themselves read from the memory medium realize the functions of the aforementioned embodiments, and the program codes and the memory medium storing such program codes constitute the present invention.

The memory medium for supplying the program codes can be, for example, a floppy disk, a hard disk, an optical disk, a magnetooptical disk, a CD-ROM, a CD-R, a DVD, a DVD-ROM, a magnetic tape, a non-volatile memory card or a ROM.

The present invention naturally includes not only a case where the functions of the aforementioned embodiments are realized by the execution of the read program codes by the computer, and a case where an operating system or the like functioning on the computer executes all the processes or a part thereof according to the instruction of the program codes thereby realizing the functions of the aforementioned embodiments.

Furthermore, the present invention naturally includes a case where the program codes read from the memory medium are once stored in a memory provided in a function expansion board inserted into the computer or a function expansion unit connected to the computer, and a CPU or the like provided in such function expansion board or function expansion unit executes all the processes or a part thereof according to the instruction of the program codes, thereby realizing the functions of the aforementioned embodiments.

What is claimed is:

1. A printing system composed of plural printing apparatus, a client apparatus capable of setting the print environment and setting the print attribute, and a server apparatus for causing at least one of the plural apparatus to execute the printing according to print data from the client apparatus, the system comprising:
holding means for holding description information describing the respective functions of the plural printing apparatus;
generation means for selecting printing apparatus based on the print environment set in the client apparatus, and generating description information describing the function of a virtual printing apparatus composed of the selected printing apparatus, based on the description information held by said holding means;
display control means for displaying an image of the print attribute on a display unit of the client apparatus, based on the description information generated by said generation means; and
control means for causing the printing apparatus constituting the virtual printing apparatus to print the print data from the client apparatus, based on the print attribute set on said image.

2. A system according to claim 1, wherein:
the description information held by said holding means includes information indicating the type of the printing apparatus;
said display control means displays an image for setting the type and number of the printing apparatus, on the display unit of the client apparatus; and
said generation means selects the printing apparatus based on the type and number set on the image, and generates the description information of the virtual printing apparatus based on the description information including information indicating the set type.

3. A system according to claim 1, wherein:
said display control means displays an image for designating the printing apparatus on the display unit of the client apparatus; and
said generation means selects the printing apparatus designated on the image, and generates the description information of the virtual printing apparatus based on the description information of the designated printing apparatus.

4. A system according to claim 1, further comprising:
input operation means capable of an input operation for renewing the content of the description information of the printing apparatus.

5. A system according to claim 1, wherein:
the description file of the virtual printing apparatus describes the function obtained by combining plural printing apparatus.

6. A system according to claim 1, wherein:
said generation means determines the number of copies that can be outputted by the virtual printing apparatus, by adding the numbers of copies that can be respectively outputted by the plural printing apparatus.

7. A system according to claim 1, wherein:
said generation means determines the number of the output bins of the virtual printing apparatus, by adding the respective numbers of the output bins of the plural printing apparatus.

8. A system according to claim 1, wherein:
said generation means determines the kinds of papers that can be processed by the virtual printing apparatus, by the kinds of papers that can be respectively processed by the plural printing apparatus.

9. A system according to claim 1, wherein:
said generation means either determines that the virtual printing apparatus has a two-side printing function in case at least one of the plural printing apparatus has the two-side printing function, or determines that the virtual printing apparatus has a sheet processing function in case at least one of the plural printing apparatus has the sheet processing function.

10. A system according to claim 9, wherein:
said sheet processing function is a stapling function, a book binding function, a folding function, a punching function, a gluing function, an enveloping function or a private box delivery function.

11. A system according to claim 1, wherein:
said control means judges whether or not to disperse the print data to plural printing apparatus based on the set print attribute, and transmits the dispersed print data to the respective printing apparatus.

12. A system according to claim 11, further comprising:
informing means for informing how the print data are dispersed, from the server apparatus to the client apparatus.

13. A print processing method for use in a printing system composed of plural printing apparatus, a client apparatus capable of setting the print environment and setting the print attribute, and a server apparatus for causing at least one of the plural apparatus to execute the printing according to print data from the client apparatus, the method comprising:
a generation step of selecting printing apparatus based on the print environment set in the client apparatus, and generating description information describing the function of a virtual printing apparatus composed of the selected printing apparatus, based on the description information;
a display control step of displaying an image of the print attribute on a display unit of the client apparatus, based on the description information generated by said generation step; and
a control step of causing the printing apparatus constituting said virtual printing apparatus to print the print data from the client apparatus, based on the print attribute set on said image.

14. A method according to claim 13, wherein:
the description information of the printing apparatus includes information indicating the type of the printing apparatus;
said display control step displays an image for setting the type and number of the printing apparatus, on the display unit of the client apparatus; and
said generation step selects the printing apparatus based on the type and number set on the image, and generates the description information of the virtual printing apparatus based on the description information including information indicating the set type.

15. A method according to claim 13, wherein:
said display control step displays an image for designating the printing apparatus on the display unit of the client apparatus; and
said generation step selects the printing apparatus designated on the image, and generates the description information of the virtual printing apparatus based on the description information of the designated printing apparatus.

16. A method according to claim 13, further comprising:
an input step for renewing the content of the description information of the printing apparatus.

17. A method according to claim 13, wherein:
the description file of the virtual printing apparatus describes the function obtained by combining plural printing apparatus.

18. A method according to claim 13, wherein:
said generation step determines the number of copies that can be outputted by the virtual printing apparatus, by adding the numbers of copies that can be respectively outputted by the plural printing apparatus.

19. A method according to claim 13, wherein:
said generation step determines the number of the output bins of the virtual printing apparatus, by adding the respective numbers of the output bins of the plural printing apparatus.

20. A method according to claim 13, wherein:
said generation step determines the kinds of papers that can be processed by the virtual printing apparatus, by the kinds of papers that can be respectively processed by the plural printing apparatus.

21. A method according to claim 13, wherein:
said generation step either determines that the virtual printing apparatus has a two-side printing function in case at least one of the plural printing apparatus has the two-side printing function, or determines that the virtual printing apparatus has a sheet processing function in case at least one of the plural printing apparatus has the sheet processing function.

22. A method according to claim 21, wherein:
said sheet processing function is a stapling function, a book binding function, a folding function, a punching function, a gluing function, an enveloping function or a private box delivery function.

23. A method according to claim 13, wherein:
said control step judges whether or not to disperse the print data to plural printing apparatus based on the set print attribute, and transmits the dispersed print data to the respective printing apparatus.

24. A method according to claim 23, further comprising:
an informing step of informing how the print data are dispersed, from the server apparatus to the client apparatus.

25. A program to be executed in a printing system composed of plural printing apparatus, a client apparatus capable of setting the print environment and setting the print attribute, and a server apparatus for causing at least one of the plural apparatus to execute the printing according to print data from the client apparatus, the program comprising:
a generation step of selecting printing apparatus based on the print environment set in the client apparatus, and generating description information describing the function of a virtual printing apparatus composed of the selected printing apparatus, based on the description information;
a display control step of displaying an image of the print attribute on a display unit of the client apparatus, based on the description information generated by said generation step; and
a control step of causing the printing apparatus constituting said virtual printing apparatus to print the print data from the client apparatus, based on the print attribute set on said image.

26. A program according to claim 25, wherein:
the description information of the printing apparatus includes information indicating the type of the printing apparatus;
said display control step displays an image for setting the type and number of the printing apparatus, on the display unit of the client apparatus; and
said generation step selects the printing apparatus based on the type and number set on the image, and generates the description information of the virtual printing apparatus based on the description information including information indicating the set type.

27. A program according to claim 25, wherein:
said display control step displays an image for designating the printing apparatus on the display unit of the client apparatus; and
said generation step selects the printing apparatus designated on the image, and generates the description information of the virtual printing apparatus based on the description information of the designated printing apparatus.

28. A program according to claim 25, wherein:
said control step judges whether or not to disperse the print data to plural printing apparatus based on the set print attribute, and transmits the dispersed print data to the respective printing apparatus.

29. A program according to claim 28, further comprising:
an informing step of informing how the print data are dispersed, from the server apparatus to the client apparatus.

30. A computer readable memory medium storing a program to be executed in a printing system composed of plural printing apparatus, a client apparatus capable of setting the print environment and setting the print attribute, and a server apparatus for causing at least one of the plural apparatus to execute the printing according to print data from the client apparatus, the program comprising:
a generation step of selecting printing apparatus based on the print environment set in the client apparatus, and generating description information describing the function of a virtual printing apparatus composed of the selected printing apparatus, based on the description information;
a display control step of displaying an image of the print attribute on a display unit of the client apparatus, based on the description information generated by said generation step; and
a control step of causing the printing apparatus constituting said virtual printing apparatus to print the print data from the client apparatus, based on the print attribute set on said image.

31. An information processing apparatus capable of communication with plural printing apparatus and an external apparatus capable of generating print data, setting print environment and setting print attribute, comprising:
holding means for holding description information describing the respective functions of the plural printing apparatus;
generation means for selecting printing apparatus based on the print environment set by the external apparatus, and generating description information describing the function of a virtual printing apparatus composed of the selected printing apparatus, based on the description information held by said holding means; and
control means for causing the printing apparatus constituting said virtual printing apparatus to print the print data from the external apparatus, based on the print attribute set by said external apparatus.

32. An apparatus according to claim 31, wherein:
the description information held by said holding means includes information indicating the type of the printing apparatus;
an image for setting the type and number of the printing apparatus is displayed on a display unit of the external apparatus; and
said generation means selects the printing apparatus based on the type and number set on the image, and generates the description information of the virtual printing apparatus based on the description information including information indicating the set type.

33. An apparatus according to claim 31, wherein:
an image for designating the printing apparatus is displayed on the display unit of the external apparatus; and
said generation means selects the printing apparatus designated on the image, and generates the description information of the virtual printing apparatus based on the description information of the designated printing apparatus.

34. An apparatus according to claim 31, wherein:
said control means judges whether or not to disperse the print data to plural printing apparatus based on the set print attribute, and transmits the dispersed print data to the respective printing apparatus.

35. An apparatus according to claim 34, further comprising:
informing means for informing how the print data are dispersed, from the information processing apparatus to the external apparatus.

36. A program to be executed by an information processing apparatus capable of communication with plural printing apparatus and an external apparatus capable of generating print data, setting print environment and setting print attribute, the program comprising:
a generation step of selecting printing apparatus based on the print environment set by the external apparatus, and generating description information describing the function of a virtual printing apparatus composed of the selected printing apparatus, based on the description information describing the functions of the respective printing apparatus; and
a control step of causing the printing apparatus constituting said virtual printing apparatus to print the print data from the external apparatus, based on the print attribute set by said external apparatus.

37. A program according to claim 36, wherein:
the description information includes information indicating the type of the printing apparatus;
an image for setting the type and number of the printing apparatus is displayed on a display unit of the external apparatus; and
said generation step selects the printing apparatus based on the type and number set on the image, and generates the description information of the virtual printing apparatus based on the description information including information indicating the set type.

38. A program according to claim 36, wherein:
an image for designating the printing apparatus is displayed on the display unit of the external apparatus; and
said generation step selects the printing apparatus designated on the image, and generates the description information of the virtual printing apparatus based on the description information of the designated printing apparatus.

39. A program according to claim 36, wherein:
said control step judges whether or not to disperse the print data to plural printing apparatus based on the set print attribute, and transmits the dispersed print data to the respective printing apparatus.

40. A program according to claim 39, further comprising:
an informing step of informing how the print data are dispersed, from the information processing apparatus to the external apparatus.

41. A computer readable memory medium storing a program to be executed by an information processing apparatus capable of communication with plural printing apparatus and an external apparatus capable of generating print data, setting print environment and setting print attribute, the program comprising:
a generation step of selecting printing apparatus based on the print environment set by the external apparatus, and generating description information describing the function of a virtual printing apparatus composed of the selected printing apparatus, based on the description information describing the functions of the respective printing apparatus; and
a control step of causing the printing apparatus constituting said virtual printing apparatus to print the print data from the external apparatus, based on the print attribute set by said external apparatus.
